(19) United States
(12) Patent Application Publication
(10) Pub. No.: US 2009/0308199 A1
(43) Pub. Date: Dec. 17, 2009

(54) ROTARY ACTUATING MECHANISM HAVING A SELECTABLE TORQUE

(76) Inventors: Thomas John Buckingham, Novi, MI (US); James Joseph Kornacki, Dearborn, MI (US)

Correspondence Address: FRASER CLEMENS MARTIN & MILLER LLC, 28366 KENSINGTON LANE, PERRYSBURG, OH, 43551, US

(21) Appl. No.: 12/137,615

(22) Filed: Jun. 12, 2008

(51) Int. Cl. F15B 21/00

(52) U.S. Cl. 74/813 C

(57) ABSTRACT

A rotary actuating mechanism for a vehicle is disclosed including at least one rotary wheel, an urging mechanism having a resistance force for producing a torque requirement for a rotation of the at least one rotary wheel, and a torque selector adapted to selectively engage the urging mechanism to adjust the resistance force thereof, wherein the torque selector selectively decreases and increases the torque requirement for the rotation of the at least one rotary wheel.

### FIELD OF THE INVENTION

The invention relates to a rotary actuating mechanism and more particularly to a rotary actuating mechanism having user selectable torque requirements.

### BACKGROUND OF THE INVENTION

The sense of touch is used in receiving haptic cues from various tasks performed on a daily basis. Haptic cues are derived from textures, bumps, torques, and vibrations, for example. Typically, a rotary actuating mechanism requires a fixed maximum amount of torque to rotate the mechanism.

In U.S. Pat. No. 4,419,546 entitled ROTARY SWITCH, hereby incorporated herein by reference in its entirety, a rotary actuating mechanism, referred to as a rotary switch, is disclosed. The rotary switch includes a detent mechanism. The detent mechanism includes a resilient plastic ring having radially outwardly extending detent bumps, which engage cam surfaces on inside walls of a switch casing. The ring includes two spring retaining head portions. Each end of a helical spring is mounted to the respective spring retaining head portion and compressed therebetween. A spring force may be selected to provide a desired haptic feel and operating torque required for specific applications. However, the spring is not accessible to a user of the rotary switch and the torque of the rotary switch is only changed by replacement of the spring.

Traditionally, the rotary actuating mechanism is limited in permitting the user to modify or select a different haptic feel. One such rotary actuating mechanism is disclosed In U.S. Pat. No. 2,919,602 entitled PROTECTIVE KNOB UNIT, hereby incorporated herein by reference in its entirety. The rotary actuating mechanism includes a bushing rotatably mounted on a sleeve. The sleeve and bushing are secured in assembled relation by a spring washer snapped into a groove in the bushing. The sleeve includes a bore having a spring and a ball disposed therein. The ball cooperates with a plurality of spaced apart recesses formed in the bushing to provide a desired haptic feel. An amount of torque necessary to rotate the rotary actuating mechanism can be adjusted by a screw threaded in the bore. The screw engages the spring to vary a spring force which urges the ball into the recesses. However, the screw is not readily accessible to a user of the rotary actuating mechanism and requires removal of a knob.

Presently, the PR-1000 Rotary Encoder manufactured by Immersion Corporation is programmable to provide multiple haptic feels and require different maximum torque amounts depending on the context of operation such as climate control, radio volume control, fade control, and the like, for example. However, the PR-1000 is suited for very high end, more expensive applications such as interior components on luxury vehicles.

Although the aforementioned rotary actuating mechanisms operate effectively, the mechanisms either do not permit the user to dynamically change a required maximum torque amount, require an addition or subtraction of components to do so, or are expensive.

Accordingly, it would be desirable to produce a rotary actuating mechanism adapted to permit a user to select a desired torque requirement, wherein a cost and complexity thereof are minimized.

### SUMMARY OF THE INVENTION

In concordance and agreement with the present invention, a rotary actuating mechanism adapted to permit a user to select a desired torque requirement, wherein a cost and complexity thereof are minimized, has surprisingly been discovered.

In one embodiment, the rotary actuating mechanism comprises at least one rotary wheel having a torque requirement for a rotation thereof; an urging mechanism adapted to contact the at least one rotary wheel, the urging mechanism having a resistance force for producing the torque requirement for the rotation of the at least one rotary wheel; and a torque selector adapted to selectively engage the urging mechanism to adjust the resistance force thereof.

In another embodiment, the rotary actuating mechanism for a vehicle comprises at least one rotary wheel having a torque requirement for a rotation thereof; an urging mechanism including a contact portion formed thereon adapted to contact the at least one rotary wheel, the urging mechanism having a resistance force for producing the torque requirement for the rotation of the at least one rotary wheel; and a torque selector adapted to selectively engage the urging mechanism to adjust the resistance force thereof, wherein the torque selector selectively decreases and increases the torque requirement for the rotation of the at least one rotary wheel, and wherein the torque selector is one of a mechanical device and an electromechanical device.

In another embodiment, the control module for a vehicle comprises a face plate having at least one switch disposed thereon; and a rotary actuating mechanism adapted to cooperate with the face plate, the rotary actuating mechanism including a knob extending through an aperture formed in the face plate; at least one rotary wheel having a torque requirement for a rotation thereof; a leaf spring including a contact portion formed thereon adapted to contact the at least one rotary wheel, the leaf spring having a resistance force for producing the torque requirement for the rotation of the at least one rotary wheel; and a torque selector adapted to selectively engage the leaf spring to adjust the resistance force thereof, wherein the torque selector selectively decreases and increases the torque requirement for the rotation of the at least one rotary wheel, wherein the torque requirement is minimized at a first positional limit of the torque selector, maximized at a second positional limit of the torque selector, and between a minimum and a maximum at a plurality of positions between the first positional limit and the second positional limit of the torque selector, and wherein the torque selector is one of a mechanical device and an electromechanical device.

### BRIEF DESCRIPTION OF THE DRAWINGS

The above and other objects and advantages of the invention will become readily apparent to those skilled in the art from reading the following detailed description of the invention when considered in the light of the accompanying drawings, in which:

FIG. 1 is a front elevational view of a control module including a rotary actuating mechanism according to an embodiment of the invention;

FIG. 2 is an enlarged fragmentary top plan view partially in section of the control module illustrated in FIG. 1;

FIG. 3 is an enlarged fragmentary rear elevational view of the control module illustrated in FIG. 2;

FIG. 4 is an enlarged fragmentary top plan view partially in section of a control module according to another embodiment of the invention;

FIG. 5 is an enlarged fragmentary rear elevational view of the control module illustrated in FIG. 4;

FIG. 6 is an enlarged fragmentary top plan view partially in section of a control module according to another embodiment of the invention; and

FIG. 7 is an enlarged fragmentary rear elevational view of the control module illustrated in FIG. 6.

### DETAILED DESCRIPTION OF THE PREFERRED EMBODIMENTS OF THE INVENTION

The following detailed description and appended drawings describe and illustrate various exemplary embodiments of the present invention. The description and drawings serve to enable one skilled in the art to make and use the invention, and are not intended to limit the scope of the invention in any manner. It is understood that materials other than those described can be used without departing from the scope and spirit of the invention.

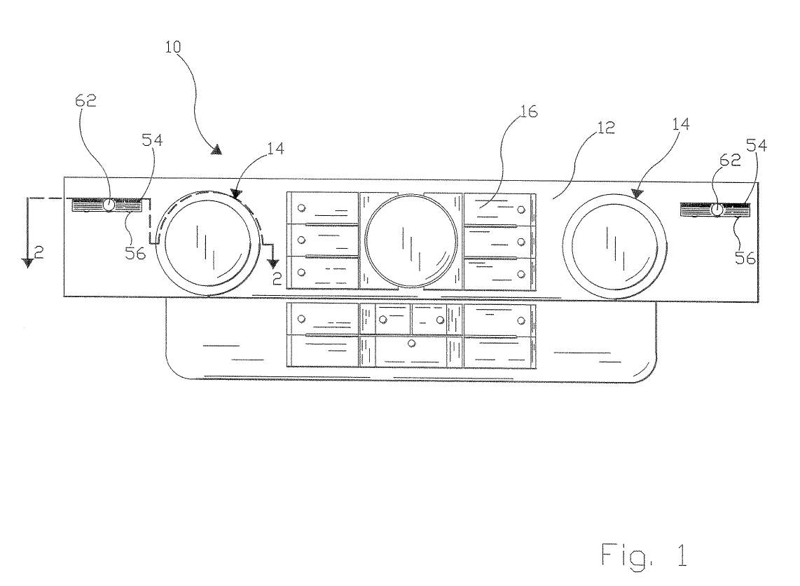

FIG. 1 shows a control module 10 for a vehicle center stack (not shown) according to an embodiment of the invention. The control module 10 includes a face plate 12, at least one rotary actuating mechanism 14, and at least one switch 16. It is understood that the rotary actuating mechanism 14 can be employed in other applications as desired. It is also understood that the at least one switch 16 can be any switch type such as a pushbutton, a dial, and the like, for example.

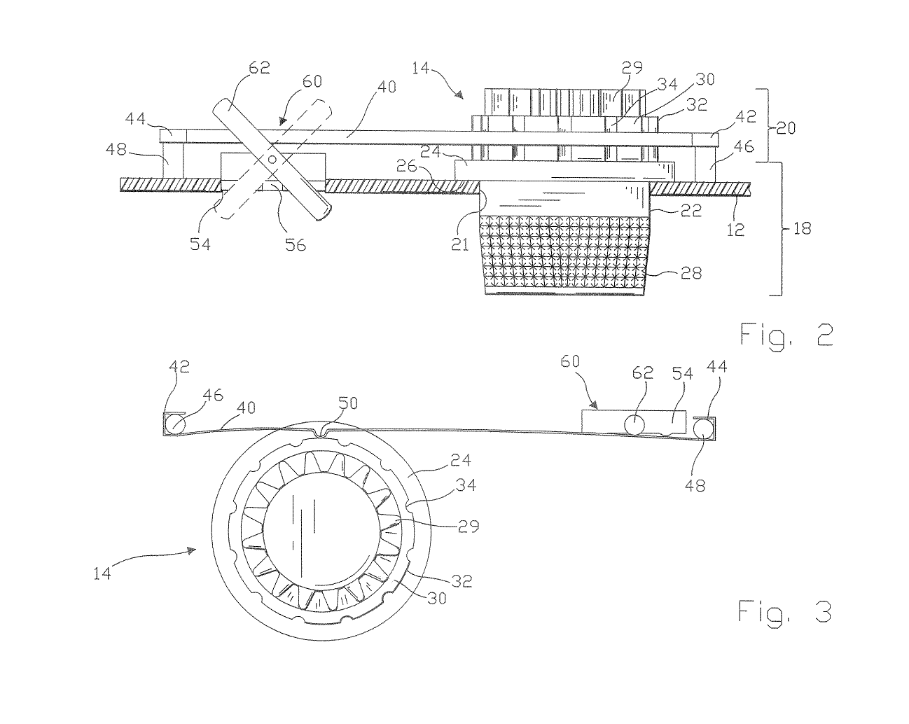

As shown in FIGS. 2 to 7, the rotary actuating mechanism 14 has a generally cylindrical shape, although it is understood that the rotary actuating mechanism 14 can have other shapes as desired. The rotary actuating mechanism 14 includes a first portion 18 and a second portion 20. The first portion 18 extends through an aperture 21 formed in the face plate 12. An outer surface 22 of the first portion 18 is received in the aperture 21 and terminates at an annular flange 24. The annular flange 24 has a first surface 26 adapted to abut a back side of the face plate 12. In the embodiment shown, the first portion 18 is a knob having a plurality of grips 28 formed thereon.

The second portion 20 includes a gear 29 and at least one rotary wheel 30. The gear 29 is adapted to drive an encoder (not shown) or a potentiometer (not shown) to interface with an electrical system (not shown) of the vehicle. The rotary wheel 30 shown is integrally formed with the gear 29 and the flange 24, although it is understood that the rotary wheel 30 can be formed separately if desired. In the embodiment shown, the rotary wheel 30 has a generally smooth outer surface 32 having at least one surface irregularity 34 formed therein such as an indentation as shown, a protuberance, a detent, and the like, for example. In the embodiment shown, the surface irregularities 34 are uniformly spaced at a predetermined distance to provide a sensation of less resistance at a discrete number of positions. It is understood that the rotary wheel 30 can be adapted to provide any haptic feel such as having no surface irregularities 34 and providing a sensation of constant resistance, for example.

The rotary actuating mechanism 14 further includes an urging mechanism 40 having a resistance force for producing a torque requirement to rotate the rotary wheel 30. Although the urging mechanism 40 illustrated is a leaf spring, it is understood that other urging mechanisms 40 can be used as desired. In the embodiment shown, the urging mechanism 40 has a generally linear shape and includes a first end 42 and a second end 44. It is understood that the urging mechanism 40 can have any shape as desired. The first end 42 and the second end 44 cooperate with respective posts 46, 48 to secure the urging mechanism 40 to the face plate 12. As shown in FIGS. 3, 5, and 7, the urging mechanism 40 further includes a contact portion 50 formed thereon. The contact portion 50 is adapted to contact the rotary wheel 30 and travel along the outer surface 32 thereof. The urging mechanism 40 illustrated is in a loaded position, whereby the rotary wheel 30 exerts a force on the contact portion 50 causing the urging mechanism 40 to deflect upwardly.

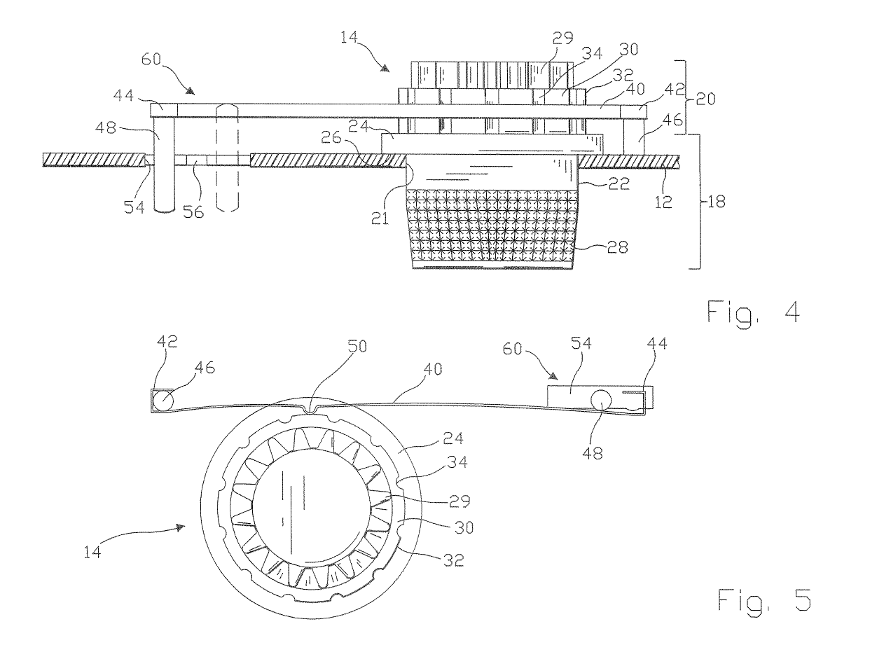

In the embodiment shown in FIGS. 2 and 3, the urging mechanism 40 is adapted to cooperate with a torque selector 60. The selector 60 is adapted to adjust the resistance force of the urging mechanism 40, and therefore, select a desired torque requirement of the rotary actuating mechanism 14. The selector 60 includes a lever 62 extending through a slot 54 formed in the face plate 12. It is understood that the lever 62 can be one of the posts 46, 48 if desired, as illustrated in FIGS. 4 and 5. The slot 54 may include at least one groove 56, as shown in FIGS. 1, 2, and 4, adapted to receive the lever 62 therein at desired positions of the urging mechanism 40.

The lever 62 is selectively movable from a first positional limit shown in FIG. 2 to a second positional limit indicated by dashed lines in FIG. 2. The lever 62 is also movable to a plurality of positions between the first positional limit and the second positional limit, such as a substantially intermediate position shown in FIG. 3, for example. It should be understood that a location of the first and second positional limits may be selected as desired. The lever 62 is accessible to a passenger of the vehicle and is adapted to selectively decrease and increase the resistance force of the urging mechanism 40 as desired, and thereby selectively decrease and increase the torque requirement of the rotary actuating mechanism 14. At the first positional limit of the lever 62, the resistance force of the urging mechanism 40 and the torque requirement of the rotary actuating mechanism 14 are minimized. At the second positional limit of the lever 62, the resistance force of the urging mechanism 40 and the torque requirement of the rotary actuating mechanism 14 are maximized.

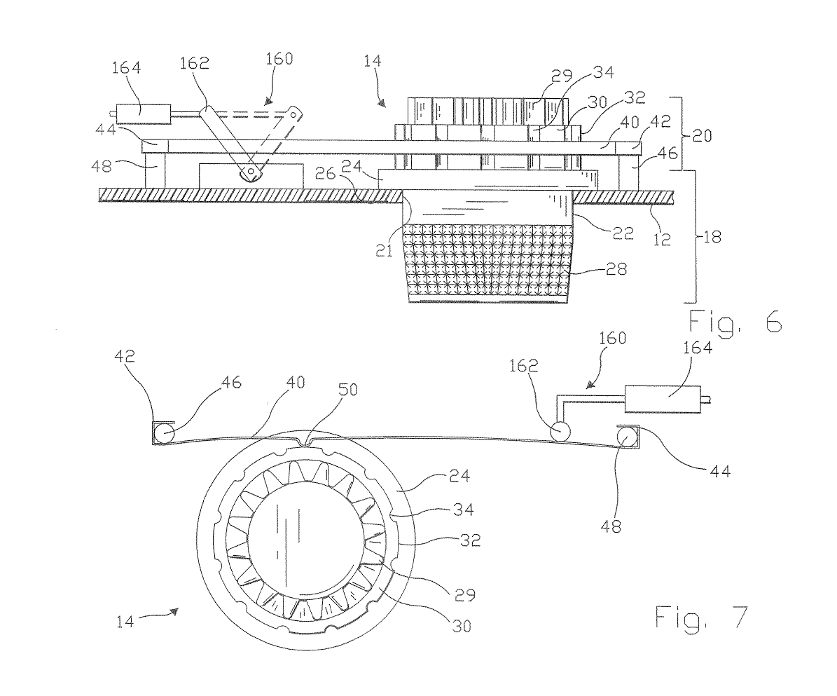

In another embodiment of the invention shown in FIGS. 6 and 7, the urging mechanism 40 is adapted to cooperate with a torque selector 160. The selector 160 is adapted to adjust the resistance force of the urging mechanism 40, and therefore, select a desired torque requirement of the rotary actuating mechanism 14. The selector 160 includes a lever 162 pivotally coupled to the face plate 12. The lever 162 is selectively movable from a first positional limit shown in FIG. 6 to a second positional limit indicated by dashed lines in FIG. 6. The lever 162 is also movable to a plurality of positions between the first positional limit and the second positional limit, such as a substantially intermediate position shown in FIG. 7, for example. It should be understood that a location of the first and second positional limits may be selected as desired. At the first positional limit of the lever 162, the resistance force of the urging mechanism 40 and the torque requirement of the rotary actuating mechanism 14 are minimized. At the second positional limit of the lever 162, the resistance force of the urging mechanism 40 and the torque requirement of the rotary actuating mechanism 14 are maximized.

As illustrated, the torque selector 160 includes a solenoid 164. The solenoid 164 is adapted to cooperate with the at least one switch 16 disposed on the face plate 12 to selectively move the lever 162 to the first positional limit, the second positional limit, and the plurality of positions between the first positional limit and the second positional limit. It is understood that the resistance force of the urging mechanism 40 can be adjusted by other mechanical and electromechanical means accessible to the passenger of the vehicle as desired.

In operation, the passenger of the vehicle selectively decreases or increases the required torque amount of the rotary actuating mechanism 14 by decreasing or increasing the resistance force of the urging mechanism 40. The resistance force of the urging mechanism 40 is selected by the passenger by urging the lever 62 as shown in FIGS. 2 to 5, activating the solenoid 164 by pushing at least one switch 16 as shown in FIGS. 6 and 7, or by an alternative mechanical and electromechanical means accessible thereto. Thereafter, the passenger uses at least the required torque amount to rotate the rotary actuating mechanism 14. The rotation of the rotary actuating mechanism 14 causes the contact portion 50 to travel along the outer surface of the rotary wheel 30 providing the desired haptic feel to the passenger.

When the passenger selectively positions one of the lever 62 or the lever 162 at the first positional limit, the resistance force of the urging mechanism 40 is minimized. Thus, the amount of torque required by the passenger to rotate the rotary actuating mechanism 14 is also minimized. Alternatively, when the passenger selectively positions one of the lever 62 or the lever 162 at the second positional limit, the resistance force of the urging mechanism 40 is maximized. Thus, the amount of torque required by the passenger to rotate the rotary actuating mechanism 14 is also maximized. Further, when the passenger selectively positions one of the lever 62 or the lever 162 at one of the plurality of positions between the first positional limit and the second positional limit, the resistance force of the urging mechanism 40 is between a minimum and a maximum. Accordingly, the amount of torque required by the passenger to rotate the rotary actuating mechanism 14 is also between a minimum and a maximum. It is understood that the passenger can dynamically change the required torque amount of the rotary actuating mechanism 14 as desired.

From the foregoing description, one ordinarily skilled in the art can easily ascertain the essential characteristics of this invention and, without departing from the spirit and scope thereof, can make various changes and modifications to the invention to adapt it to various usages and conditions in accordance with the scope of the appended claims.

What is claimed is:

1. A rotary actuating mechanism comprising:
at least one rotary wheel having a torque requirement for a rotation thereof;
an urging mechanism adapted to contact the at least one rotary wheel, the urging mechanism having a resistance force for producing the torque requirement for the rotation of the at least one rotary wheel; and
a torque selector adapted to selectively engage the urging mechanism to adjust the resistance force thereof.

2. The mechanism according to claim 1, wherein the urging mechanism is a leaf spring.

3. The mechanism according to claim 1, wherein the torque selector is a mechanical device.

4. The mechanism according to claim 3, wherein the mechanical device includes a lever.

5. The mechanism according to claim 1, wherein the torque selector is an electromechanical device.

6. The mechanism according to claim 5, wherein the electromechanical device includes a lever coupled to a solenoid adapted to be activated by at least one switch.

7. The mechanism according to claim 1, wherein the torque selector selectively decreases and increases the torque requirement for the rotation of the at least one rotary wheel.

8. The mechanism according to claim 1, wherein the torque requirement for the rotation of the at least one rotary wheel is minimized at a first positional limit of the torque selector.

9. The mechanism according to claim 1, wherein the torque requirement for the rotation of the at least one rotary wheel is maximized at a second positional limit of the torque selector.

10. The mechanism according to claim 1, wherein at the torque requirement for the rotation of the at least one rotary wheel is between a minimum and a maximum at a plurality of positions between a first positional limit and a second positional limit of the torque selector.

11. A rotary actuating mechanism for a vehicle comprising:
at least one rotary wheel having a torque requirement for a rotation thereof;
an urging mechanism including a contact portion formed thereon adapted to contact the at least one rotary wheel, the urging mechanism having a resistance force for producing the torque requirement for the rotation of the at least one rotary wheel; and
a torque selector adapted to selectively engage the urging mechanism to adjust the resistance force thereof, wherein the torque selector selectively decreases and increases the torque requirement for the rotation of the at least one rotary wheel, and wherein the torque selector is one of a mechanical device and an electromechanical device.

12. The mechanism according to claim 11, wherein the urging mechanism is a leaf spring.

13. The mechanism according to claim 11, wherein the mechanical device includes a lever accessible by a passenger of a vehicle.

14. The mechanism according to claim 11, wherein the electromechanical device includes a lever coupled to a solenoid adapted to be activated by at least one switch accessible by a passenger of a vehicle.

15. The mechanism according to claim 11, wherein the torque requirement for the rotation of the at least one rotary wheel is minimized at a first positional limit of the torque selector.

16. The mechanism according to claim 11, wherein the torque requirement for the rotation of the at least one rotary wheel is maximized at a second positional limit of the torque selector.

17. The mechanism according to claim 11, wherein the torque requirement for the rotation of the at least one rotary wheel is between a minimum and a maximum at a plurality of positions between a first positional limit and a second positional limit of the torque selector.

18. A control module for a vehicle comprising:
a face plate having at least one switch disposed thereon; and
a rotary actuating mechanism adapted to cooperate with the face plate, the rotary actuating mechanism including:
a knob extending through an aperture formed in the face plate;
at least one rotary wheel having a torque requirement for a rotation thereof;
a leaf spring including a contact portion formed thereon adapted to contact the at least one rotary wheel, the leaf spring having a resistance force for producing the torque requirement for the rotation of the at least one rotary wheel; and
a torque selector adapted to selectively engage the leaf spring to adjust the resistance force thereof, wherein the torque selector selectively decreases and increases the torque requirement for the rotation of the at least one rotary wheel, wherein the torque requirement is minimized at a first positional limit of the torque selector, maximized at a second positional limit of the torque selector, and between a minimum and a maximum at a plurality of positions between the first positional limit and the second positional limit of the torque selector, and wherein the torque selector is one of a mechanical device and an electromechanical device.

19. The control module according to claim 18, wherein the mechanical device includes a lever extending through a slot formed in the face plate, the lever accessible by a passenger of a vehicle.

20. The control module according to claim 18, wherein the electromechanical device includes a lever coupled to a solenoid adapted to be activated by the at least one switch accessible by a passenger of a vehicle.
